(19) United States
(12) Patent Application Publication
(10) Pub. No.: US 2002/0156696 A1
(43) Pub. Date: Oct. 24, 2002

(54) System and method for micropayment in electronic commerce

(76) Inventor: Mordechai Teicher, Hod Hasharon (IL)

Correspondence Address: Eitan Pearl Latzer & Cohen Zedek, One Crystal Park Suite 210, 2011 Crystal Drive, Arlington, VA, 22202-3709, US

(21) Appl. No.: 10/089,458

(22) PCT Filed: Aug. 8, 2001
(86) PCT No.: PCT/IL01/00731

(30) Foreign Application Priority Data
Aug. 11, 2000 (US) 60224328
Nov. 16, 2000 (US) 60248573

(51) Int. Cl. G06F 17/60

(52) U.S. Cl. 705/26

(57) ABSTRACT

A method and system for making micropayments over a network by stored value without requiring customers to have stored-value apparatus such as smart cards and/or smart card readers. A secure stored-value device is operated by a service provider (such as an ISP, telephony provider, mobile operator, electronic retailer, or bank) with which the customer has an established account with regular billing. The customer orders merchandise over the network and the service provider pays the supplying merchant with stored value, and bills the customer via its regular service bill. Other customers having their own stored-value payment devices may pay merchants directly using their stored-value payment devices.

### FIELD AND BACKGROUND OF THE INVENTION

The present invention relates to virtual payment in electronic commerce, and, in particular, to virtual micropayment using stored value.

Electronic commerce is rapidly evolving. More and more merchants receive orders for physical and virtual merchandise ova the Internet, and consumer-s can place orders via the Internet using a personal computer, a screen phone, a mobile telephone, a set-top box, or a personal digital assistant The term “virtual merchandise” herein denotes merchandise which can be embodied as some form of pure information, and which may therefore be delivered from the seller to the purchaser directly over the network without physical interaction. Non-limiting examples of virtual merchandise include music and other audio content; news, reference, directory, and financial information; communications services; computer software and games, photographs, videos, graphics, and other images; reservations, tickets, and licenses. Compatible payment solutions have been developed, the majority of which axe based on charging the payment to a credit or debit card.

Payment by mobile telephones extends beyond electronic commerce, Mobile telephones are sophisticated, relatively secure units carried by an increasing number of consumers, and this has led to the use of mobile telephones to identify their owners and access funds for making payments in vending machines, toll booths, parking, and general retail.

Many of the goods sold via electronic or mobile commerce are of low cost: digital content such as music titles, news, games, photos, graphics, and so forth, or low-cost physical items purchased by mobile phones from vending machines, kiosks, newsstands, and the like. Charging small amounts ranging from a few cents to a few dollars via credit or debit is economically prohibitive, since the per-transaction processing costs of credit and debit charges are high compared to the fees collectable for such small payments. The term “micropayment” herein denotes such a payment that is too small to economically process via a credit or debit charge. Thus, micropayments over the Internet and micropayments made by mobile phones require a dedicated solution other than credit or debit charge. The term “virtual micropayment” herein denotes a micropayment made over a communications channel, without the physical presence of the payer before the payee.

The micropayment challenge has already been identified and dealt with in physical commerce to replace cash in small payments, such as those encountered in vending, parking, newsstands, fast food, and so forth. The solutions have all been built around “stored-value” (SV) technology. SV technology provides the ability to store and transfer value in a way which is secured against unauthorized creation of value or double-spending of the same stored value. It is widely accepted that only a special-purpose integrated circuit (“chip”) with an appropriate operating system and cryptographic capabilities can provide the required level of security. Such chips are embedded into “smart cards”, secure application modules (SAM) within merchant point-of-sale (POS) terminals, mobile telephones, and so forth.

Various designs for stored-value payment systems have been described and/or implemented in the market, including Mondex, Proton, Geldkarte, and Ultimus. While Mondex, Proton, and Geldkarte store and transfer value that represents electronic cash, Ultimus (described in U.S. Pat. Nos. 5,744,787, 6,076,075, 6,065,675, and 6,119,946) uses stored value to temporarily retain the unused part of previous credit and debit transactions.

Solutions so far presented for making micropayments over the Internet, without the need for the consumer to open accounts with specific merchants, can be classified into two groups;

1. Using stored-value cards to make payment over the Internet via a secure protocol between the customer's card and the merchant's server; and

2. Billing the transactions to the customer's account with a service provider (e.g. Internet, telephony, mobile telephony), and settling the aggregated balances (accumulated from many customers of the service providers buying from the same merchant) between the service provider (SP) and the merchant.

Neither of the above has so far proven to be successful. The limitation of the first solution is in the need to provide every customer with a smart card and a smart card reader. Because this is currently not feasible, there is no incentive for merchants to accept stored-value payments. This in turn discourages consumers from acquiring smart cards and smart card readers, and thereby perpetuating this limitation. The limitation of the second approach is in requiring a global access of the service provider to merchants, to cover the global market represented by the Internet today. Service providers would be required to establish payment accounts with a large number of merchants in order to offer their subscribers a broad variety of merchandise. This would place a heavy burden on the service providers and detract from their principal business, which is providing Internet, telephony, or mobile telephony service. This limitation therefore restricts the size and scope of merchandising based on setting up payment accounts between service providers and merchants.

There is thus a widely recognized need for, and it would be highly advantageous to have, a system and method for handling micropayments over a network that neither requires consumers to acquire individual smart cards and readers, nor requires service providers to establish billing accounts with merchants. This goal is met by the present invention.

### OBJECT AND SUMMARY OF THE INVENTION

The object of the present invention is to provide an efficient and effective stored value-based payment solution for electronic commerce, which overcomes the limitations of the prior art described above.

Stored-value (SV) payment will relate hereinafter to all the payment solutions involving stored-value technology for micropayment, including, but not limited to, Mondex, Proton, Geldkarte, and Ultimus mentioned in the background above. U.S. Pat. Nos. 5,744,787, 6,076,075, 6,065,675, and 6,1119946 are incorporated by reference as if set forth fully herein.

In its simplest form, the present invention can be described as placing a smart card and a smart card reader (or an equivalent heavy-duty SV device featuring smart card security) with service providers, who pay with SV to merchants on behalf of their customers and bill the customers for their purchases. Optionally, other customers, who prefer to pay directly to the merchant, can acquire a smart card and reader and make the purchases by themselves using the same SV payment system.

According to a first aspect of the present invention, there is provided a stored-value (SV) payment system, including:

a merchant server to advertise goods for sale, receive orders, collect SV payment and supply the goods; and

a service provider (SP) computer to make SV payments to the merchant and bill the customer therefor.

According to a second aspect of the present invention, the merchant server can receive orders and SV payments from customers either via their service provider as described above, or directly from customers who have a stored-value payment unit (such as a smart card and a smart card reader connected to a personal computer, or an SV chip contained in a mobile telephone).

In a third aspect of the present invention, the SV used to pay the merchant can be received by a stored-value POS at the merchant premises. Alternatively, such a unit can be located remotely from the merchant, such as by the merchant's acquiring bank or by a third-party service, whereby payments are received on behalf of the merchant, with reports sent to the merchant for fulfillment of the respective orders.

It is noted that the service provider can be an Internet service provider (ISP), a telephone company, a mobile telephony operator, a utility provider, a bank, or any other entity which has, or which can establish, efficient billing relations with a large number of consumers.

The present invention is preferably implemented by an SV payment system provided and supported by the banks and payment associations. In this way, the payment between the SP and merchant uses a standard payment platform which relies upon the global presence and expertise of the banks and payment associations in operating payment systems, while the customer-SP billing is based on existing, local billing systems and well established customer-supplier relations.

According to the present invention, the SP can be a communication service provider (Internet, telephony, mobile telephony), a utility provider having efficient billing arrangements with its customers, or a dedicated electronic retail store established by banks or other entrepreneurs. By virtue of making payments to merchants via SV at the time of purchase, the SP does not need to establish any special billing arrangements with the merchant.

However, also according to the present invention, the SP could establish a relationship with the merchant whereby the SP acts as a retailer interfacing between the customer and the merchant, who acts as a wholesaler. Under such a relationship, the SP would be entitled to a wholesale discount on merchandise. The SP could treat this discount as additional earnings or alternatively pass all or part of the discount to the customer as a marketing incentive to use the SP's services. Alternatively, the SP can bill an additional fee to the customer for providing this merchandise service.

According to Variations of the present invention, instead of the merchant's commerce server including or being connected to a stored-value payment unit, such a unit may receive payment on behalf of the merchant and send the merchant a payment receipt acknowledgement, upon receipt of which the merchant would release the merchandise to the customer. In this case, the stored-value payment unit that receives payment on behalf of the merchant can be placed at the merchant premises but connected to payers separately from the connection to the commerce server. Alternatively, the stored-value payment unit may be placed remotely (such as at the site of a service provider), or may be operated by a trusted third party (such as the merchant's acquiring bank) to receive payment for the merchant. In the two latter cases, the stored-value payment unit can be dedicated exclusively to the merchant or a single such unit can be shared among a plurality of merchants, with accounting separated according to a merchant identification included in each stored-value payment.

In time, customers using the SP's interface to make micropayments, may acquire an SV payment interface for their own personal computer or mobile telephone, and then switch all or part of their purchases to direct orders to the merchants without involving the SP. Thus, the present invention allows for flexibility and evolution.

Therefore, according to the present invention there is provided a system for making a first micropayment for a first purchase by a first customer to a first merchant, the system including: (a) a stored-value point-of-sale for receiving the first micropayment on behalf of the first merchant; (b) a service provider computer including a service provider stored-value payment unit for making the first micropayment to the stored-value point-of-sale; and a customer billing unit for billing the first customer in accordance with the making of the first micropayment; and (c) a first customer terminal operable by the first customer to make the first purchase, the first purchase including the first micropayment.

Furthermore, according to the present invention there is also provided a method for making a payment from a customer to a merchant for a merchandise item via a service provider, the method including the steps of: (a) sending an order for the merchandise item from the customer to the service provider; (b) making a stored-value payment for the merchandise item to the merchant from the service provider; and (c) billing the customer for the merchandise item by the service provider.

### BRIEF DESCRIPTION OF THE DRAWINGS

The invention is herein described, by way of example only, with reference to the accompanying drawings, wherein:

FIG. 1 is a block diagram of a system according to the present invention

FIG. 2 is a flowchart illustrating a payment method according to the present invention.

FIGS. 3A-C are block diagrams describing variations of the present invention.

FIGS. 4A-B are block diagrams describing additional variations of the present invention.

### DESCRIPTION OF THE PREFERRED EMBODIMENTS

The principles and operation of a payment system and method according to the present invention may be understood with reference to the drawings and the accompanying description.

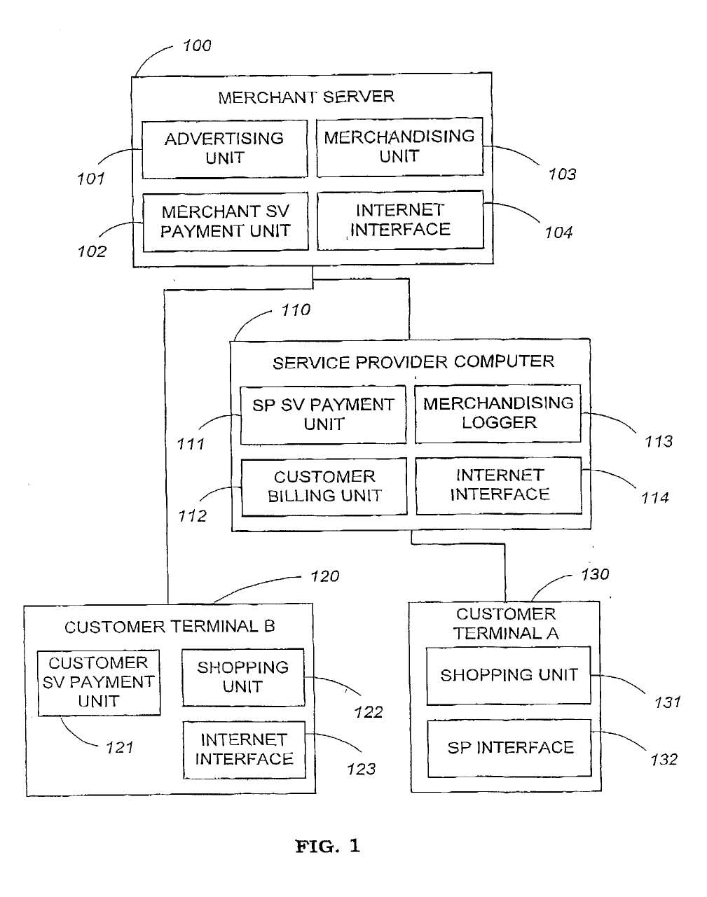

FIG. 1 is a block diagram illustrating a payment system according to the present invention. A merchant server 100 is connected to the Internet via an interface 104. An advertising unit 101 provides information to interested customers about products, prices, special offers, etc. A merchandising unit 103 receives orders and ships goods according to customer requests. A merchant stored-value payment unit 102 receives and settles payments by stored value (for example, payments according to Mondex, Proton, Geldkarte, or Ultimus and settlement of the received stored value with the respective SV issuers/acquirers). Merchant server 100 may include also a regular payment unit (not shown) for credit or debit card billing for higher purchases.

A service provider (SP) computer 110 is operated as an add-on service by a communication service provider (Internet, telephony, mobile telephony) which serves and bills customers for communication services, or by a dedicated electronic retail store connected to the Internet. Service provider computer 110 is connected to the Internet via an interface 114. A merchandising logger 113 keeps track of customer orders for handling questions and resolving disputes, A payment unit 111 makes SV micropayments to unit 102 of merchant server 100. A customer billing unit 112 records all micropayments made by the SP to the merchant on behalf of customers, and adds them to the respective customers' bills.

A customer terminal “type A” 130 uses the services of SP computer 110 to place orders with merchant sever 100, and is connect to the internet via an SP interface 132. The customer uses a shopping unit 131 to browse via the servers of various merchants and place and record orders. Payment for orders is made via SP computer 110 in two steps: the SP pays merchant server 100 via SV payment unit 111, and then bills the customer via billing unit 112. The amount paid by unit 111 may be lower than that billed by unit 112, the difference being the discount the SP receives from the merchant and/or the fee paid by the customer.

A customer terminal “type B” 120, includes m independent SV payment unit 121. Therefore, the customer can operate shopping unit 122 to order directly from and pay directly to merchant server 100, using any internet link via interface 123.

It is noted that payment unit 102 of merchant server 100 receives the same form of SV micropayment, whether made directly by a customer using terminal “type B” 120 or indirectly by a customer using terminal “type A” 130 to pay via SP computer 110.

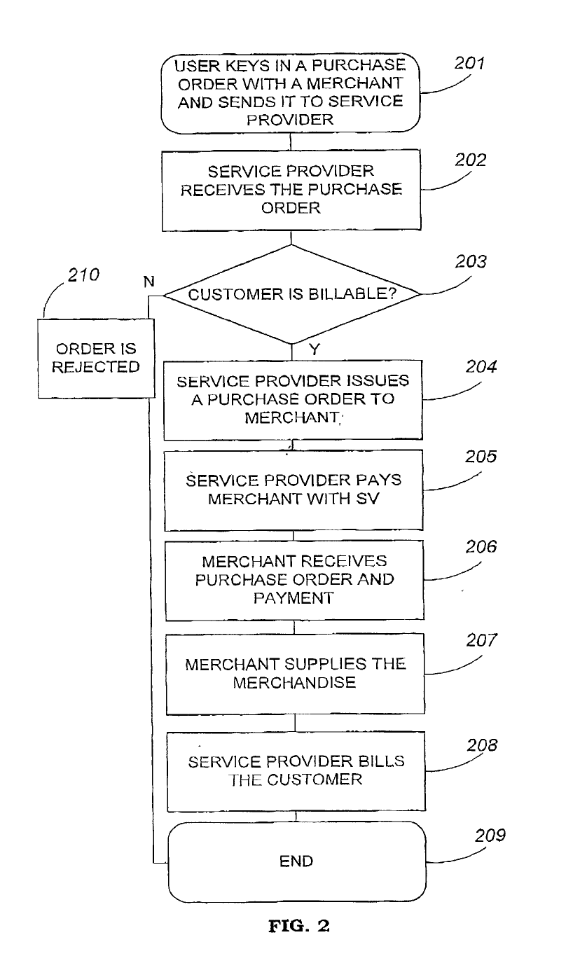

FIG. 2 is a flowchart describing the payment method according to the present invention for a customer using terminal “type A” 130 (FIG. 1). In a step 201, the customer uses shopping unit 131 (FIG. 1) to browse via various offers, select a desired item with a selected merchant, and send the order to SP computer 110 (FIG. 1). In a step 202 the payment is received, and in at decision point 203 the order is checked to see if the customer is billable. If the customer is not found to be billable (e.g. the customer has no account with the SP or has a bad history record), the order is rejected in a step 210. Otherwise, a purchase order is issued in a step 204, and in a step 205 the SP makes fall payment by SV. In a step 206 the purchase order and payment are received by the merchant In a step 207 the merchandise is supplied to the customer, either via the SP or directly (for example, a music clip is sent directly to the email address of the customer, upon an order placed through all SP who is a mobile operator). In a step 208 the SP bills the customer via the regular billing (such as a mobile service bill). The amount billed by the SP to the customer in step 208 may be higher than the amount paid by the SP to the merchant in step 205, the difference being a discount granted by the merchant to the SP and/or a fee paid by the customer.

In an alternative embodiment of the method described above, the customer may send the order directly to the merchant, in which case the merchant sends a copy of the order to the service provider, and the service provider does not need to send a purchase order to the merchant.

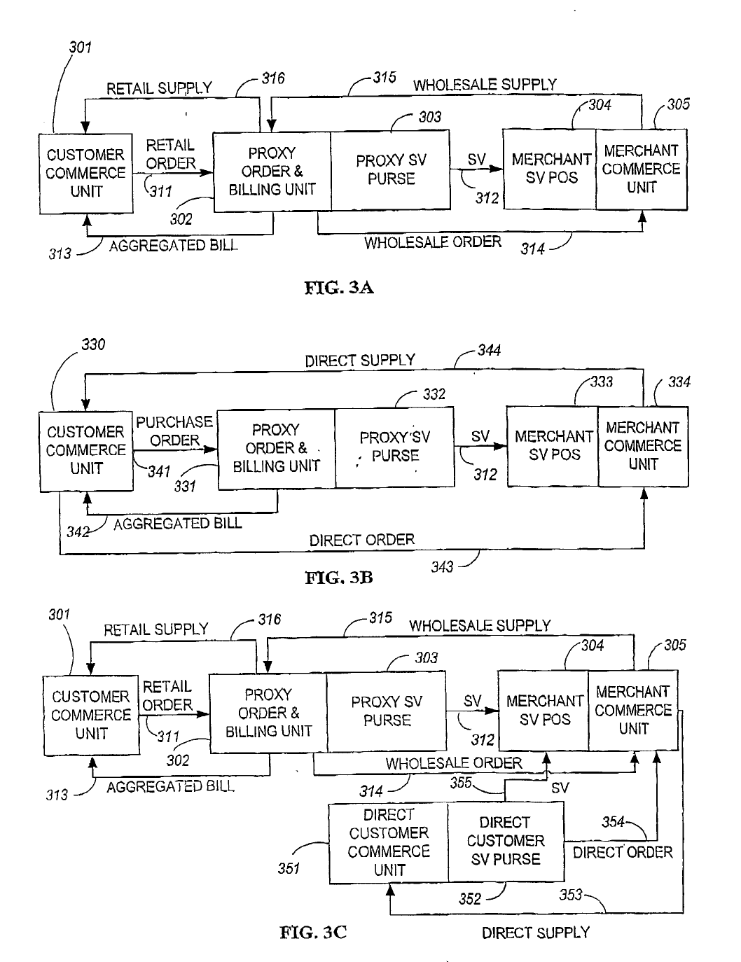

FIG. 3A is an alternative block diagram of the system described in FIG. 1. A customer commerce unit 301 (such as a web browser or a mobile telephone) is used to place a retail order 311 with a proxy server 302 (a proxy such as a service provider). Retail order 311 is transformed at server 302 into a wholesale order 314 made by proxy server 302 at a merchant server 305, with a corresponding stored-value payment 312 made by a proxy SV purse 303 into a merchant stored-value point-of-sale 304. Upon receiving wholesale order 314 and payment 312, merchant server 305 sends merchandise (for example, digital content) via a wholesale supply link 315 to proxy server 302, which relays the merchandise via a retail supply link 316 to customer commerce unit 301. An aggregated bill 313 is presented by merchant server 302 for payment at the end of the month, or when the total bill reaches a predefined maximum.

FIG. 3B describes an alternative embodiment, wherein the proxy (such as a service provider) is involved in payment only, while the order and supply of the merchandise are handled directly between the customer and the merchant. A customer commerce unit 330 communicates via the Internet with a merchant server 334 to select an item, place a tentative order and get a payment order number (PON). A purchase order 341 including the merchant identity and the PON is sent to a proxy server 331. Proxy server 331 sends the PON (not shown) to merchant server 334 while transferring payment (usually under wholesale discount) by stored value 312 from a proxy purse 332 to a merchant stored-value POS 333. Merchant POS 333 then supplies merchandise via a direct supply link 344 directly to customer unit 330. An aggregated bill 342 is presented in a manner similar to that illustrated in FIG. 3A.

FIG. 3C describes another variation of FIG. 3A, wherein, in addition to the combination of retail and wholesale transactions shown in FIG. 3A, a customer having a stored-value purse 352 attached to a commerce unit 351 may place a direct order 354 with merchant server 305, pay directly by stored value 355 from purse 352 to POS 304, and receive merchandise by a direct supply link 353.

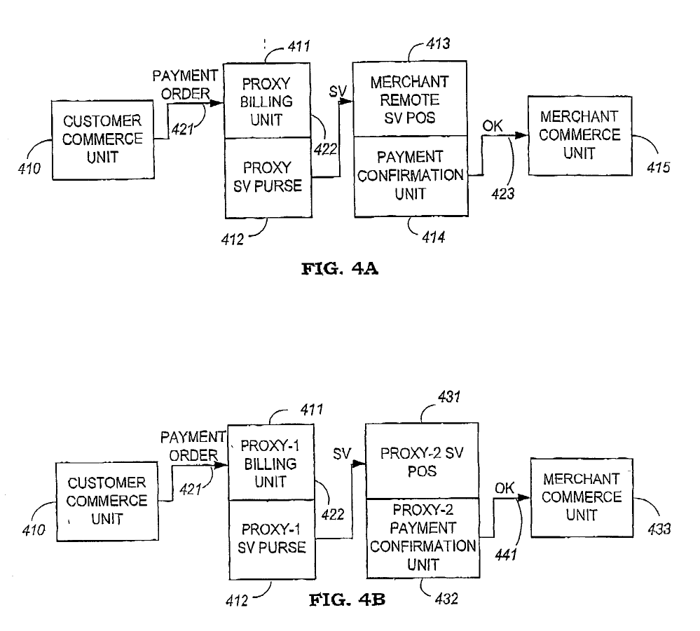

FIG. 4A describes a further variation of the present invention, wherein a merchant remote POS 413 is separate from a merchant commerce server 415. This may be desirable, for example, to minimize the modifications needed at an existing merchant commerce server. La this variation, a customer commerce unit 410 is used to place a payment order 421 with a proxy billing unit 411, which causes a proxy stored-value purse 412 to pay the required amount to merchant remote POS 413. As a result, a payment conformation unit 414 sends a payment acknowledgement message 423 to merchant commerce server 415, which then releases the merchandise. The merchandise order and supply elements are omitted from FIG. 4A, which illustrates only payment for clarity. It is noted that units 413 and 414 can be located at the merchant premises, or at a remote service center.

FIG. 4B describes a variation of FIG. 4A, wherein a remote POS 431 and a payment unit 432 are operated by a trusted proxy of tie merchant (such as the acquiring bank). In this case, units 431 and 432 can receive payment on behalf of a number of merchants. Thus, when payment 422 is made by proxy stored-value purse 412 to proxy stored-value POS 431, a merchant identification (not shown) is attached to payment message 422, which accordingly routes this transaction to the respective merchant's account, and then transmits a payment confirmation message 441 to the respective merchant server.

While the invention has been described with respect to a limited number of embodiments, it will be appreciated that many variations, modifications and other applications of the invention may be made.

What is claimed is:

1. A system for making a fist micropayment for a first purchase by a first customer to a first merchant, the system comprising:
(a) a stored-value point-of-sale for receiving said first micropayment on behalf of said first merchant;
(b) a service provider computer including a service provider stored-value payment unit for making said first micropayment to said stored-value point-of-sale; and a customer billing unit for billing said first customer in accordance with said making of said first micropayment; and
(c) a first customer teal operable by said first customer to make said first purchase, said first purchase including said first micropayment.

2. The system of claim 1 for farther making a second micropayment for a second purchase by a second customer to said first Merchant, the system further comprising a second customer terminal operable by the second customer to make the second purchase, said second customer terminal including a customer stored-value payment unit to make the second micropayment for the second purchase into said stored-value point-of-sale.

3. The system of claim 1, wherein the first merchant operates a first commerce server and said stored-value point-of-sale forms part of said first commerce server.

4. The system of claim 1, wherein said first merchant operates a first commerce server and said stored-value point-of-sale is remote from said first commerce server and is operative to sending a payment acknowledgement signal to said first commerce server upon receiving said payment from said service provider stored-value payment unit.

5. A method for making a payment from a customer to a merchant for merchandise via a service provider, the method comprising the steps of:
(a) sending an order for the merchandise from the customer;
(b) making a stored-value payment for the merchandise to the merchant from the service provider, and
(c) billing the customer for the merchandise by the service provider.
